(19) United States
(12) Patent Application Publication
(10) Pub. No.: US 2016/0320656 A1
(43) Pub. Date: Nov. 3, 2016

(54) DISPLAY PANELS HAVING PENETRATION EFFECT

(71) Applicant: SHENZHEN CHINA STAR OPTOELECTRONICS TECHNOLOGY CO., LTD, Shenzhen, Guangdong (CN)

(72) Inventor: Hsiao Hsien CHEN, Shenzhen, Guangdong (CN)

(21) Appl. No.: 14/413,145

(22) PCT Filed: Jan. 24, 2014
(86) PCT No.: PCT/CN2014/071429

§ 371 Date: Jan. 6, 2015

(30) Foreign Application Priority Data
Dec. 31, 2013 (CN) 201310753978.0

(51) Int. Cl. G02F 1/1347; G02F 1/1343; G02F 1/1335; G02B 26/00

(52) U.S. Cl. CPC G02F 1/13476; G02B 26/005; G02F 1/13439; G02F 1/133512; G02F 2201/44; G02B 2207/115

(57) ABSTRACT

The present invention further provides a display panel having penetration effect, includes a plurality of main pixels, each main pixel includes a plurality of primary sub-pixels, each sub-pixel includes a first substrate, a second substrate, and a display layer being set between two substrates, liquid crystal molecules are distributed on the display layer, wherein transparent electrodes are set between the first and the second substrates; a light-shielding controlling layer is set on either side of the display panel and formed by an electro wetting display panel. The different display effects, such as the transparent state, the penetration state, the opaque state, etc., could be obtained by respectively changing the conduction situations of the display layers and the light-shielding layers of the sub-pixels, which adds artistic effects and diverse imaging, furthermore, the clarity of the screen could be improved and the operator's privacy could protected.

### FIELD OF THE INVENTION

The present invention relates to liquid crystal displays, and more particular, refers to display panels having penetration effect.

### BACKGROUND OF THE INVENTION

Items behind a display screen could be seen through the display by penetration effect thereof, which makes the display have sense of future. However, the things behind the screen could be seen with main display items together, and therefore to affect display ratio of items on screen, which makes it not easy to see what displayed on the screen. In addition, a man being on other side of the screen could see the screen currently used, so protection for privacy is inadequate.

### SUMMARY OF THE INVENTION

On account of the lack of the prior art, an object of the present invention is to provide a display panel having penetration effect, by which visual contrast of screen display could be enhanced, privacy of operators could be protected, and diversity of image display could be increased.

The present invention provides a display panel having penetration effect, comprising a plurality of main pixels, each main pixel comprising a plurality of primary sub-pixels, each sub-pixel comprising a first substrate, a second substrate, and a display layer being set between two substrates, liquid crystal molecules being distributed on said display layer, wherein each said sub-pixel being respectively provided with transparent electrodes, and the transparent electrodes being isolated each other, display state of the display panel being adjusted by applying voltage to the transparent electrodes of the pixels.

Preferably, a light-shielding controlling layer is set onto either side of the display panel and formed by an electro wetting display panel. Light shielding or transmission could be adjusted by controlling the light-shielding controlling layers.

Preferably, each said electro wetting display panel comprises a positive electrode, a negative electrode, a polar solution layer and a non-polar solution layer, wherein the non-polar solution layer is disposed above the electrodes, said negative electrode is set above said positive electrode, and said non-polar solution layer is set above the negative electrode. Said non-polar solution layers could shrink to edges of the pixels to transmit lights when the electro wetting display panels are conducted; said non-polar solution layers could tile all over the light-shielding controlling layer to absorb incident lights when the electro wetting display panels are not conducted.

Said non-polar solution of the light-shielding controlling layers could tile respectively the whole light-shielding controlling layers in a non-conducted sub-pixel area when the electro wetting display panels are not conducted while the display layers of at least one set of sub-pixels are conducted, and the liquid crystal molecules on the display layers reflect the lights to show pictures; in conducted sub-pixel areas, the lights penetrate the display layers and are absorbed by the non-polar solution of the light-shielding controlling layers, the whole display panel should be in an opaque display status.

Said non-polar solution layers could be absorbed and shrink to the edges of the pixels in the light-shielding controlling layers of each sub-pixel when the electro wetting display panel and the display layers of all the sub-pixels are conducted, the incident lights penetrate the display layers and the light-shielding controlling layers to make the whole display panel be in a transparent display state.

Said non-polar solution layers of each sub-pixel could be absorbed and shrink to the edges of the pixels in the light-shielding controlling layers when the electro wetting display panels are conducted while the display layers of a part of the sub-pixels are not conducted; the incident lights penetrate the display layers and the light-shielding controlling layers in the conducted pixel areas, the incident lights would be reflected by the liquid crystal molecules, thus to make the whole display panel be in a transparent display state.

The present invention further provides a display panel having penetration effect, comprising a plurality of main pixels, each main pixel comprising a plurality of primary sub-pixels, each sub-pixel comprising a first substrate, a second substrate and a third substrate, and a display layer being set between two substrates, liquid crystal molecules being distributed on said display layer, transparent electrodes being set between the first and the second substrates to control turning direction of the liquid crystal molecules; a light-shielding controlling layer being set between the second and the third substrates and formed by an electro wetting display panel, said electro wetting display panel comprising a polar solution layer and a non-polar solution layer, states of the liquid crystal molecules and the non-polar solution layers being controlled by controlling conduction states of the light-shielding controlling layers as well as the display layers of the whole or part of the sub-pixels, thus to adjust the display states of the display plane.

Compared with prior arts, the display panel having penetration effect of the present invention, by which the liquid crystal molecules could be controlled to refract, reflect or transmit the incident light by separately controlling the conduction of the display layers of each sub-pixel. The liquid crystal molecules would reflect or refract the light when the display layers are not conducted, and transmit the light when the layers are conducted. Meanwhile, the non-polar solution layer could be controlled to refract, reflect or transmit the incident light by combining the control of the light-shielding controlling layers. The non-polar solution layer could be tiled on the light-shielding controlling layers when they are not conducted, and the incident lights would be absorbed by the non-polar solution layers to shield the lights and show pictures; the non-polar solution layers would be attracted and shrinks up to the edges of the pixels when they are conducted, and the incident lights would pass through the display layers and the light-shielding controlling layers to show a transparent effect. The different display effects, such as the transparent state, the penetration state, the opaque state, etc., could be obtained by respectively changing the conduction situations of the display layers and the light-shielding layers of the sub-pixels, which adds artistic effects and diverse imaging, furthermore, the clarity of the screen could be improved and the operator's privacy could protected.

### BRIEF DESCRIPTION OF THE DRAWINGS

FIG. 1 is a schematic diagram of a display panel structure having penetration effect of a first embodiment of the invention;

FIG. 2 is a schematic diagram of a display panel structure having penetration effect of a second embodiment of the invention;

FIG. 3 is a schematic diagram of a display panel structure having penetration effect of a third embodiment of the invention;

FIG. 4 is a schematic diagram of a display panel structure having penetration effect of a forth embodiment of the invention;

FIG. 5 is a schematic diagram of a display panel structure having penetration effect of a fifth embodiment of the invention; and

FIG. 6 is a schematic diagram of a display panel structure having penetration effect of a sixth embodiment of the invention.

### DETAILED DESCRIPTION OF THE PREFERRED EMBODIMENTS

The present invention provides display panels having penetration effect and having working modes: transparent display mode, non-transparent display mode, and penetration display mode. Structures of the display panels would be described below respectively according with different operating modules.

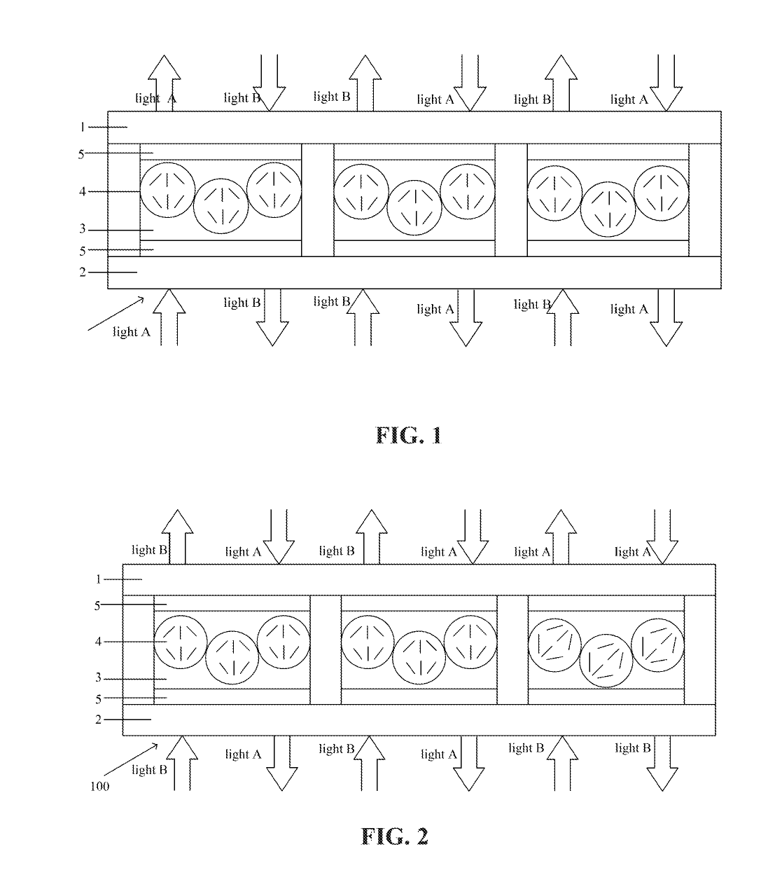

Referring to FIG. 1, a display panel having penetration effect of a first embodiment includes a plurality of main pixels, wherein each pixel includes a plurality of primary sub-pixels, each sub-pixel 100 includes the first substrate 1, a second substrate 2, and a display layer being set between two substrates 1 and 2, liquid crystal molecules 4 are distributed on the display layer, wherein each sub-pixel is respectively provided with transparent electrodes 5, and the transparent electrode 5 are isolated each other. Display states of the display panel could be adjusted by applying voltages onto the transparent electrodes 5 of any sub-pixels. Wherein the transparent electrodes 5 are disposed respectively above the first substrate 1 and below the second substrate 2, and the liquid crystal molecules are type of holographic polymer dispersed liquid crystal (HPDLC). The liquid crystal molecules 4 would be arranged along an electric field orderly and arrangement directions of them are same when a voltage is applied onto the transparent electrodes 5. For the raison of the same refractive index of the liquid crystal molecules in terms of front incident lights, none of reflection or refraction phenomenon would take place on the display layer 3 if the refractive index of material of the substrates is same to that of the liquid crystal, which results that the incident lights might penetrate the display layer 3 to make the whole display plane clear and transparent.

Referring to FIG. 2, each sub-pixel of the display panel might be respectively controlled electrically to obtain the penetration effect. In the second embodiment, the transparent electrodes of the rightmost sub-pixel are not energized, while transparent electrodes of the leftmost sub-pixel are energized, at this time, the liquid crystal molecules could be orderly aligned in the electric field in two sub-pixels of the left side, so that the incident lights could penetrate the two sub-pixels and thereby showing the penetration phenomenon in the area; while in the rightmost sub-pixel area, the refraction and the reflection might take place on the surface of the respective liquid crystal molecules due to the different refractive index, and scattering would occur after multiple times of the refraction and the reflection to reflect back the incident lights to an observer, so that the observer might see background behind the display panel. In the left two energized sub-pixel areas, the lights penetrate to show the penetration state thereon. Therefore, the observer standing in front of the display panel would see not only the screen, but also the background behind the display panel at the same time when a part of the sub-pixels are energized, while another part of sub-pixels are not energized, so that the screen could generate the sense of the future. However, the background would affect the clarity of the screen that the user observes, meanwhile the others on the opposite side of the operator could also see what being shown on the screen.

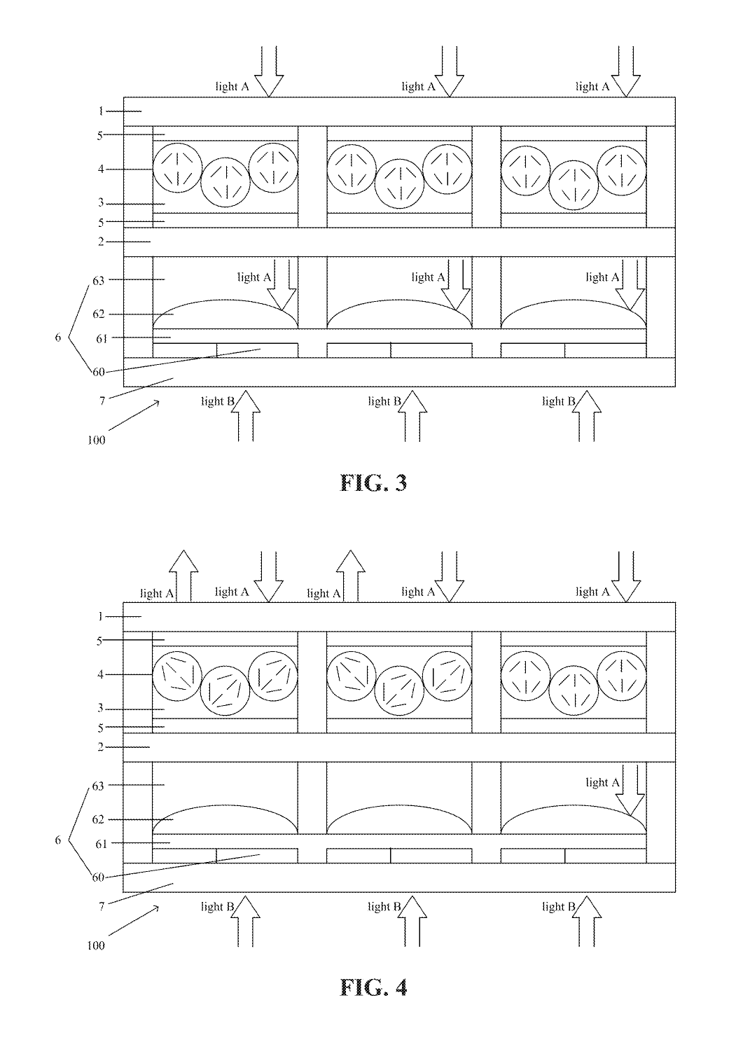

Referring to FIG. 3, for the third embodiment, a light-shielding layer 6, formed by Electro Wetting Display (EWD) panel, could be further added onto the display panel. The light-shielding layer 6 could adjust shading or transmission of lights. Wherein the electro wetting display panel includes a positive electrode 60, a negative electrode 61, a polar solution layer 62 and a non-polar solution layer 63. The non-polar solution layer 63 is located above the electrode, the negative electrode 61 is provided above the positive electrode 60, and the non-polar solution layer 63 is disposed above the negative electrode 61. The non-polar solution layer 63 would shrink to the edges of the pixels to make the lights pass through when the electro wetting display panel is in the energized state; the non-polar solution layer 63 would cover all over the light-shielding layer 6 to absorb the incident lights when the electro wetting display panel is in the non-energized state. The states of the non-polar solution layer 63 located on the light-shielding layer 6 could be changed by controlling the energized state of the electro wetting display panel, thereby controlling the absorption or the penetration of the incident lights. The non-polar solution layer 63 has tiled and filled on the light-shielding layer 6 before applying voltage for the electro wetting display panel, and at the moment, the incident lights would be absorbed by the non-polar solution layer 63 to generate a shading effect, the background could be isolated to increase the clarity thereof, and the screen could not be seen on the opposite side of the operator, thereby avoiding the operator give his privacy away.

Referring to FIG. 4, when the electro wetting display panel is not conducted and the display layer of at least one set of sub-pixel is conducted, the non-polar solution of the light-shielding controlling layer would cover the entire light-shielding controlling layer in the non-energized sub-pixel area, and the liquid crystal molecules in the display layer would reflect the light to show pictures; in the energized sub-pixel area, the lights penetrate the display layer and are absorbed by the non-polar solution layer of the light-shielding controlling layer, so that the overall display screen shows an opaque state. In the fourth embodiment, when the electro wetting display panels are not conducted, and the display layers of two sub-pixels to the left side is not conducted, while the display layers of sub-pixels to the right side is conducted, at this time, on the display layers of the left two sub-pixels, the liquid crystal molecules reflect the incident light to show pictures, and on the display layers of the right sub-pixel, the light could penetrate the display layers to show a black state as the electro wetting display panels are not energized and the non-polar solution layers absorb the lights.

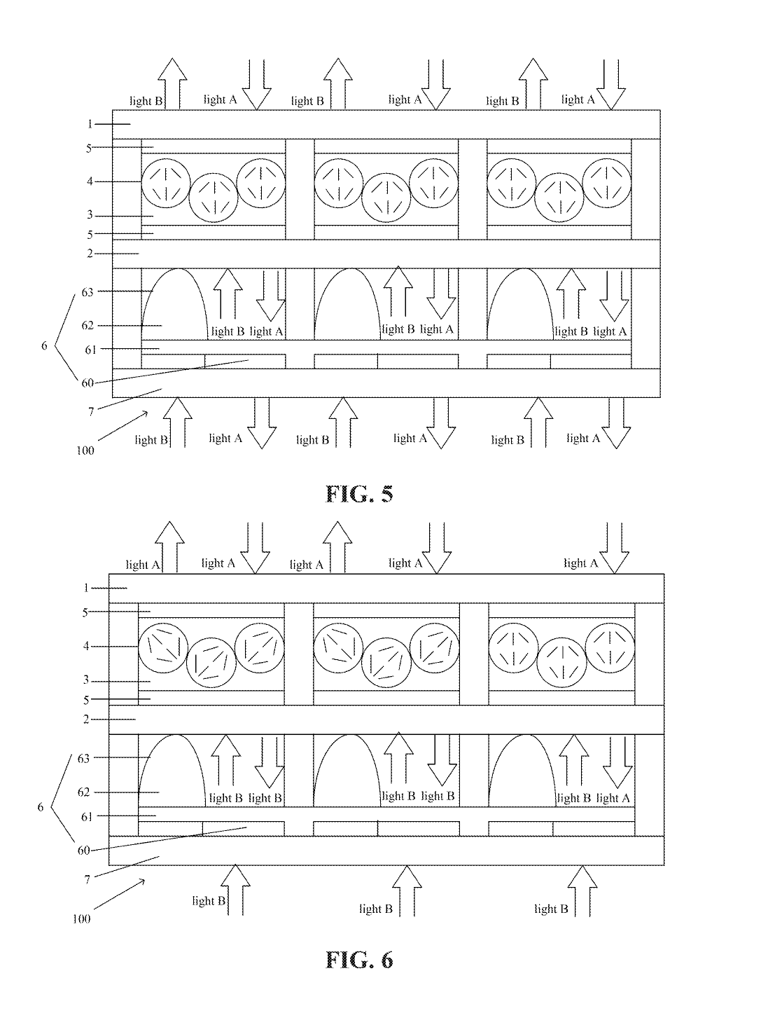

Referring to FIG. 5, the non-polar solution layer should be attracted and shrink up to the edges of the pixels when the electro wetting display panels are conducted and the display layers of all the sub-pixel are conducted on the light-shielding controlling layer of each sub-pixel, the incident lights penetrate the display layers and the light-shielding controlling layers, which results that the overall screen is in a transparent state. In the fifth embodiment, the non-polar solution layer of the light-shielding controlling layer should be attracted and shrink up to the edges of the pixels when the electro wetting display panels are conducted to show the transparent state; if the display layer is also conducted, the lights penetrate the display layers and the light-shielding controlling layers to show the transparent state.

Referring to FIG. 6, the non-polar solution layer of each sub-pixel is attracted and shrinks up to the edges of the pixels in the light-shielding controlling layers when the electro wetting display panels are conducted and the display layers of a part of the sub-pixel are non conducted; the incident lights penetrate the display layers and the light-shielding controlling layers in the energized sub-pixel area; in the non-energized areas of the sub-pixels, the incident lights are reflected by the liquid crystal molecules of the display layers to show pictures, so that the whole screen is in a transparent state. In the sixth embodiment, when the electro wetting display panels is conducted while the display layers of the left two sub-pixels are not conducted, then the liquid crystal molecules would reflect the light to show pictures; for the display layers the right sub-pixels are conducted, the lights could penetrate the display layers and the light-shielding controlling layers to maintain the transparent display state.

The display panel having penetration effect of the present invention includes a plurality of main pixels, wherein each main pixel includes a plurality of sub-pixels. Each sub-pixel includes a first substrate, a second substrate 2 and a third substrate. A display layer is set between the first substrate and the second substrate, and liquid crystal molecules are distributed on the display layer. Transparent electrodes are disposed between the first substrate and the second substrate to control diversion of the liquid crystal molecules; a light-shielding controlling layer is provided between the second substrate and the third substrate and formed by a electro wetting substrate. The electro wetting substrate contains a polar solution layer and a non-polar solution layer, moving direction of the non-polar solution layer could be controlled by applying a voltage to part or all of the sub-pixels, thus to control the showing status of the display panel.

Because of the display panel having penetration effect of the present invention, the liquid crystal molecules could be controlled to refract, reflect or transmit the incident light by separately controlling the conduction of the display layers of each sub-pixel. The liquid crystal molecules would reflect or refract the light when the display layers are not conducted, and transmit the lights when the layers are conducted. Meanwhile, the non-polar solution layers could be controlled to refract, reflect or transmit the incident light by combining the control of the light-shielding controlling layers. The non-polar solution layers could be tiled on the light-shielding controlling layer when they are not conducted, and the incident lights would be absorbed by the non-polar solution layers to shield the lights and show pictures; the non-polar solution layers would be attracted and shrinks up to the edges of the pixels when they are conducted, and the incident lights pass through the display layers and the light-shielding controlling layers to show the transparent effect. The different display effects, such as the transparent state, the penetration state, the opaque state, etc., could be obtained by respectively changing the conduction situations of the display layers and the light-shielding layers of the sub-pixels, which adds artistic effects and diverse imaging, furthermore, the clarity of the screen could be improved and the operator's privacy could protected.

What is claimed is:

1. A display panel having penetration effect, comprising a plurality of main pixels, each main pixel comprising a plurality of primary sub-pixels, each sub-pixel comprising a first substrate, a second substrate, and a display layer being set between two substrates, liquid crystal molecules being distributed on said display layer, wherein each of said sub-pixels is respectively provided with transparent electrodes, and the transparent electrodes are isolated each other, display state of the display panel is adjusted by applying voltage on said transparent electrodes of any sub-pixels, a light-shielding controlling layer further is set onto either side of the display panel and formed by an electro wetting display panel, said electro wetting display panel comprises a positive electrode, a negative electrode, a polar solution layer and a non-polar solution layer, and the non-polar solution layer is disposed on the electrode.

2. The display panel having penetration effect according to claim 1, wherein said negative electrode is set above said positive electrode, and said non-polar solution layer is set above said negative electrode.

3. The display panel having penetration effect according to claim 1, wherein said non-polar solution layer shrinks up to edges of the pixels to transmit lights when said electro wetting display panels are conducted; said non-polar solution layers tile the whole light-shielding controlling layers to absorb incident lights when said electro wetting display panels are not conducted.

4. The display panel having penetration effect according to claim 3, wherein said non-polar solution of the light-shielding controlling layers tile the whole light-shielding controlling layers in non-conducted areas of the sub-pixels, and the liquid crystal molecules on the display layers reflect the lights to show pictures when the electro wetting display panels are not conducted, while the display layers of at least one set of sub-pixel are conducted; in conducted areas of the sub-pixels, the lights penetrate the display layers are absorbed by the non-polar solution of the light-shielding controlling layers, so that the whole display panel is in an opaque display status.

5. The display panel having penetration effect according to claim 3, wherein said non-polar solution layers are absorbed to the edges of the pixels in the light-shielding controlling layers of each sub-pixel when the electro wetting display panels are conducted and the display layers of all the sub-pixels are conducted, the incident lights penetrate the display layers and the light-shielding controlling layers to make the whole display panel be in a transparent display state.

6. The display panel having penetration effect according to claim 3, wherein said non-polar solution layers of each sub-pixel are absorbed and shrink to the edges of the pixels in the light-shielding controlling layers when the electro wetting display panels are conducted and the display layers of a part of the sub-pixels are not conducted; the incident lights penetrate the display layers and the light-shielding controlling layers in the conducted areas of the sub-pixels, the incident lights are reflected by the liquid crystal molecules in the non-conducted areas of the sub-pixels, thus to make the whole display panel be in a transparent display state.

7. A display panel having penetration effect, comprising a plurality of main pixels, each main pixel comprising a plurality of primary sub-pixels, each sub-pixel comprising a first substrate, a second substrate, and a third substrate, and a display layer being set between two substrates, liquid crystal molecules being distributed on said display layer, transparent electrodes being set between the first and the second substrates to control turning direction of the liquid crystal molecules; a light-shielding controlling layer being set between the second and the third substrates and formed by an electro wetting display panel, said electro wetting display panel comprising a polar solution layer and a non-polar solution layer, states of the liquid crystal molecules and the non-polar solution layers being controlled by controlling conduction states of the light-shielding controlling layers as well as the display layers of whole or part of the sub-pixels, thus to adjust the display states of the display plane.

8. A display panel having penetration effect, comprising a plurality of main pixels, each main pixel comprising a plurality of primary sub-pixels, each sub-pixel comprising a first substrate, a second substrate, and a display layer being set between two substrates, liquid crystal molecules being distributed on said display layer, wherein each said sub-pixels is respectively provided with transparent electrodes, and the transparent electrodes are isolated each other, display states of the display panel is adjusted by applying voltage on said transparent electrodes of any sub-pixels, thus to adjust the display states of the display plane.

9. The display panel having penetration effect according to claim 8, wherein as light-shielding controlling layer further is set on either side of the display panel and formed by an electro wetting display panel.

10. The display panel having penetration effect according to claim 9, wherein said electro wetting display panel comprises a positive electrode, a negative electrode, a polar solution layer and a non-polar solution layer, and the non-polar solution layer is disposed on the electrode.

11. The display panel having penetration effect according to claim 10, wherein said negative electrode is set above said positive electrode, and the non-polar solution layer is disposed on the negative electrode.

12. The display panel having penetration effect according to claim 11, said non-polar solution layers shrink to the edges of the pixels to transmit lights wherein when the electro wetting display panels are conducted; said non-polar solution layers tile all over the light-shielding controlling layers to absorb incident lights when the electro wetting display panels are not conducted.

13. The display panel having penetration effect according to claim 12, wherein when the electro wetting display panels are not conducted, while the display layers of at least one set of sub-pixel are conducted, said non-polar solution of the light-shielding controlling layers tile the whole light-shielding controlling layers in the non-conducted areas of the sub-pixels, and liquid crystal molecules on the display layers reflect the lights to show pictures; in the conducted areas of the sub-pixels, the lights penetrate the display layer and are absorbed by the non-polar solution of the light-shielding controlling layers, the whole display panel is in an opaque display status.

14. The display panel having penetration effect according to claim 12, wherein said non-polar solution layers are absorbed and shrink to the edges of the pixels in the light-shielding controlling layers of each sub-pixel when the electro wetting display panels and the display layers of the whole sub-pixels are conducted, the incident lights penetrate the display layers and the light-shielding controlling layers to make the whole display panel be in a transparent display state.

15. The display panel having penetration effect according to claim 12, wherein when the electro wetting display panels are conducted while the display layers of a part of the sub-pixels are not conducted, said non-polar solution layers of each sub-pixel are absorbed and shrink to the edges of the pixels in the light-shielding controlling layers; the incident lights penetrate the display layers and the light-shielding controlling layers in the conducted areas of the pixels, the incident lights are reflected by the liquid crystal molecules, thus to make the whole display panel be in a transparent display state.
